(19) United States
(12) Patent Application Publication
(10) Pub. No.: US 2007/0142995 A1
(43) Pub. Date: Jun. 21, 2007

(54) Adaptation of an automatic distance control to traffic users potentially merging into the lane thereof

(75) Inventor: Bernd Wotlermann, Fellbach (DE)

Correspondence Address: STEPHAN A. PENDORF, P.A., PENDORF & CUTLIFF, 5111 MEMORIAL HIGHWAY, TAMPA, FL, 33634, US

(73) Assignee: DaimlerChrysler AG

(21) Appl. No.: 10/582,286

(22) PCT Filed: Oct. 26, 2004
(86) PCT No.: PCT/EP04/12057

§ 371 Date: Jun. 12, 2006

(30) Foreign Application Priority Data
Dec. 11, 2003 (DE) 103 58 034.4

(51) Int. Cl. B60T 7/12

(52) U.S. Cl. 701/96; 701/117

(57) ABSTRACT

According to the invention, the security and driving comfort on driving road vehicles is increased by the fitting thereof with automatic systems for distance control and traffic separation. The operating properties of vehicles filled with such systems may be better adapted to traffic users merging into the lane thereof and the operating properties essentially better matched to those of a human vehicle driver, whereby an automatic traffic separation is carried out in which the position and speed of objects and traffic users are detected by a separation sensor. The vehicle is then subjected to a braking or acceleration, depending on said detected information. According to the invention, other information relating to the road layout from a navigation system or other data-bank containing road layout data is accessed, such that when the above information indicates that a detected traffic user under normal conditions is expected to merge into the lane of the road vehicle comprising said system, the driving properties of said road vehicle are matched to those of the detected traffic user.

### CROSS-REFERENCE TO RELATED APPLICATION

This application is a national stage of PCT/EP2004/012057 filed Oct. 26, 2004, and based upon DE 103 58 034.4 filed on Dec. 11, 2003 under the International Convention.

### BACKGROUND OF THE INVENTION

1. Field of the Invention

The invention concerns a process for adapting the distance control for automatic safe following in motor vehicles to traffic users merging into their lane, as well as a device suitable for carrying out the process.

For increasing the safety and the driving comfort in the guidance of motor vehicles in traffic, these are today increasingly equipped with automatic systems for vehicle following control or safe separation control, by means of which the vehicle automatically maintains a safe separation from a preceding motor vehicle.

2. Description of Related Art

An example of a device of this general type is described in European Laid Open Publication EP0605104A1, which device includes a distance sensor, an evaluation unit and an adjustable speed influencing servo device which is under the control of control parameters calculated by the evaluation unit. The distance sensor is, for a example, a millimeter wavelength radar, a lidar or an ultrasound sensor and senses the environment ahead of the road vehicle in order to detect objects or traffic users located therein. The sensor angle is therein generally selected such that objects on adjacent lanes can also be detected. The environment data detected by the distance sensor is transmitted to the evaluation unit, so that, having knowledge of the speed of the equipped vehicle, the speed of the other detected traffic users can be arrived at. Starting with a safe distance to be maintained, which is generally selected depending upon the speed, a speed-dependent following time t_{f} is computed. If the equipped vehicle has a higher speed than a recognized preceding traffic user in the same lane, then the following time t_{f} continuously decreases. If this decrease reaches a preset threshold, then the evaluation unit produces a control parameter or signal which acts on the speed governing servo device in such a manner that the speed of the equipped vehicle is reduced. The distinction as to whether an object or a traffic user is located in the same lane or an adjacent lane occurs herein on the basis of a defined lane breadth. Besides the observation of traffic users in the lane being driven by the equipped vehicle, the evaluation unit determines, using the data from the distance sensor, also the direction of movement of the traffic users in adjacent lanes. If the traffic user moves from an adjacent lane into the defined lane breadth, then the evaluation unit evaluates this traffic user as closest traffic user and controls the speed of the equipped vehicle to be so far below it that the following time t_{f} is maintained with respect to this traffic user. This control operation however, in particular in “pincers” movements (hazards closing in from both sides of the equipped vehicle), frequently leads to an abrupt reduction in the speed of the equipped vehicle, since traffic users changing into lane of other traffic frequently leave only a very small spacing between vehicles following behind them in their lane.

In order to attenuate or cushion this type of abrupt speed change, it is proposed in German Laid Open Publication DE10160189A1, to design the rules of behavior of the system for automatic following guidance in such a manner that upon detecting a traffic user in the vicinity of a road merger or junction it takes note of this fact and in connection therewith recognizes that the ahead lying road area approaches the own lane. Subsequently an increased alertness of the area detected by the distance sensor is observed for merging vehicles. On the basis of the recognition that a potential merging vehicle is located in the immediate vicinity, it can be more rapidly and reliably detected already in the first detection cycle in which it is recognized by the distance sensor and identified as such. In this manner a relevant merging vehicle can already be recognized very early, so that more time remains for adjusting the following time t_{f} and as a result the speed of the equipped vehicle is reduced less abruptly.

For increasing the time necessary for adjusting the following time t_{f} and for creating a more comfortable following guidance conforming more closely to the human driving behavior of a vehicle, it is proposed in German Patent DE198 04 944C2 to detect the transverse acceleration of a traffic user located in the adjacent lane and approaching the lane of the equipped vehicle. If herein a transverse speed of a traffic user located in an adjacent lane towards the equipped vehicle is detected, then a conclusion is drawn as to an imminent merging. Accordingly, here also the environment area observed by the distance sensor is widened, in order to better observe this merging vehicle. Since, as a result of the evaluation of the transverse speed, a merging of a traffic user can be recognized on the basis of its change in position already prior to the merging thereof into the lane of the distance regulated vehicle, the control process can be improved and be adapted to the driving behavior of a human motor vehicle operator. In situations in which the merging traffic user however undertakes a relatively rapid lane change, it could also happen that, in the vehicle safe distance guidance described in DE19804944C2, an abrupt speed change of the vehicle could not be avoided.

### SUMMARY OF THE INVENTION

The task of the invention is thus to provide a process for adaptation of an automatic safe following distance guidance of a vehicle (10) to a traffic user merging into ones own lane (B), as well as a device suitable for carrying out this process, which avoids abrupt speed changes of the vehicle in the adjustment of the following time to the traffic user and to imitate the driving behavior of a human motor vehicle operator.

This task is solved by a process and by a device suitable for carrying out the process. Advantageous embodiments and further developments of the invention are described in the dependent claims.

In this new process for adaptation of an automatic following guidance of a road vehicle (10) to a traffic user (20) merging into ones own lane (B), objects and traffic users (20) ahead of their own vehicle are detected within a detection area (12) originating from a separation sensor. Subsequently in an evaluation unit the position and speeds of the detected objects and traffic users (20) are determined, in order to, beginning with this computed data, to produce controlled parameters in order to specifically act on servo means for acceleration or deceleration of the vehicle. In inventive manner, for this in the generation of the controlled parameters supplementally taken into consideration, besides the data regarding the object and the traffic users (20) ascertained in the evaluation unit also information from a navigation system describing the course of the road ahead or a data bank containing information regarding the course of the road is accessed. In the case that it is determined that, from the information regarding the further course of the road, that at least on of the detected traffic users in normal driving behavior would change to the lane (B) of the vehicle (10), the controlled parameters for the servo means acting on the vehicle (10) are produced in such a manner, that the driving behavior of the road vehicle (10) adapts to the at least one detected traffic user (20) depending upon its vehicle speed and/or position. Included in the typical information regarding the further course of the road, from which it can be determined, that a traffic user detected therein in the normal vehicle behavior would change to the lane (B) of the vehicle, there belong in particular information regarding junctions, highway on ramps or reduction in available lanes; for example the narrowing of a three lane highway to a two lane highway, in which the vehicles located on the lane which ends must merge into an adjacent lane.

The invention therewith which makes it possible, from recognition of the own vehicle position and with reference to supplemental additional information describing the course of the road in a mode and manner looking to the future to already early so adjust the speed of the vehicle that for a potential merging traffic already early place has been provided, which leads to a significantly more harmonious driving behavior. In this advantageous manner the operator of the motor vehicle has the feeling that the system drives by looking ahead in the manner of an ideal human driving behavior.

In the frame work of the invention for the production of object data from the environment of the inventive system including the motor vehicle all types of separation sensors known from the state of the art can be employed, in particular advantageously millimeter waive length radars, lidars or distance resolving camera systems. In particularly advantageously manner information describing the ahead lying course of the street from the ADAS (Map Advanced Driver Assistance System) can be read, which besides the information necessary for vehicle navigation also includes supplemental information regarding the number of lanes (AB) and/or marking with respect to on and off ramps (C) on highways or major streets. From this type of map material, as well as from knowing the position of the vehicle it is possible using the ADAS-Maps relatively precisely to determine for example the position of on ramps, sense their locational positioning is relatively precise. If in the course of the street lying ahead of the own vehicle for example an on ramp is recognized and if in this on ramp a traffic user is recognized, it can be assumed, that this will merge accordingly to conventional driving behavior from the on ramp onto the thereto adjacent lane. If the on vehicle is located on this adjacent lane, then it can already, in contrast to the systems known from the state of the art, already before the recognized traffic user even has begun the merging process, by suitable adjustment of the servo parameters the on vehicle can be controlled or regulated in such a manner in its speed that for the ahead line merging of the other traffic user space can be made available.

If on the other hand it is recognized from the information from the navigation system describing the ahead line course of the road or from another data bank (for example the ADAS-Map) that an on ramp leads to an additional lane running parallel to the previous lane, then the evaluation unit does not exert influence by the production of servo or controlled parameters on the speed of the own vehicle. The progression guidance does not react in this type of this situation to the recognized traffic user, since in the case of a conventional mode of driving the traffic user it is not reliably recognized that the traffic user will carry out a lane change; in such a situation the human driver of the own vehicle will also not react to this traffic user with a change of the vehicle speed, rather he would maintain the vehicle speed and only carefully observe the driving behavior of the other traffic user.

### BRIEF DESCRIPTION OF THE DRAWINGS

Of course the functionality of the invention is not limited to the forward looking recognition of merging behavior on on-ramps, but can rather for example in the same manner also be employed advantageously in situations in which in the ahead lying course of the road the number of drivable lanes is reduced and wherein the traffic users located on the disappearing lane must merge to the remaining lanes.

In the following the invention will be described in greater detail on the basis of illustrative examples and with aide of the figures.

FIG. 1. Shows a merging situation on an on ramp on a multi-lane road.

FIG. 2. Shows the scene corresponding to FIG. 1, in which vehicles involved in the merging process are located at other positions.

FIG. 3. Likewise shows the scene corresponding to FIG. 1 or 2, in which the vehicles involved in the merging process are again located at other positions.

FIG. 4. Likewise shows a scene corresponding to FIGS. 1, 2 or 3, in which the merging vehicles are located in the dead zone area of the merging vehicle.

### DETAILED DESCRIPTION OF THE INVENTION

A typical merging situation on an on ramp of a multi-lane road is illustrated in FIG. 1. For this a vehicle 10 moves along a multi-lane road with lanes A and B on lane B in the direction of the directional arrow 11. The C corresponds to an on and off ramp onto the roadway with the lanes A and B. The vehicle 10 is equipped with an inventive system for recognition of merging vehicles, wherein the limitations of a for example sensing or detection range of the separate sensor included in the system is indicated by dashed lines 12. In the examples shown in FIGS. 1 through 4 the sensing area of the separation sensor is so arranged that it overlaps wide areas of lanes A, B, and C. A vehicle 20 is moving along lane C, which is located in the sensing area 12 of the separation sensor and therewith is detected by the inventive system. Based on the assumption of a typical driving behavior it is then to be presumed, that the vehicle 20 will change from lane C to lane B along a trajectory 21a or 21b or 21c (or a similar trajectory). Whatever the possible trajectory is selected by the driver of the vehicle in the course of his change or merging process is selected cannot be predicted in a situation as illustrated in FIG. 1, since the vehicle is still driving straight ahead and therewith no significant transverse movement can be measured. By means of the evaluation of the sensor data of the separation sensor however the relative speed of the vehicle 20 can be measured in reference to the own vehicle 10.

In order to allow vehicle 20 a optimal, interference free merger process it is possible in advantageous manner in those cases, in which the speed of the at least one detected traffic user 20 exceeds the own speed of the vehicle 10, to so adapt the driving behavior of the own vehicle 10 to that of the traffic user 20, that by a suitable adjusting of the servo parameter the speed of the own vehicle 10 is reduced to the realm of the speed of the traffic user 20. (In the case of the speed of the detected traffic user 20 is exceeded by the own. speed of the own vehicle 10). In this manner, the distance between the two vehicles remains essentially constant, so that the driver of the 10 does not experience an uncomfortable approaching to the vehicle 20, and also the operator of the vehicle 20 is implicitly telegraphed the possibility of a safe merger.

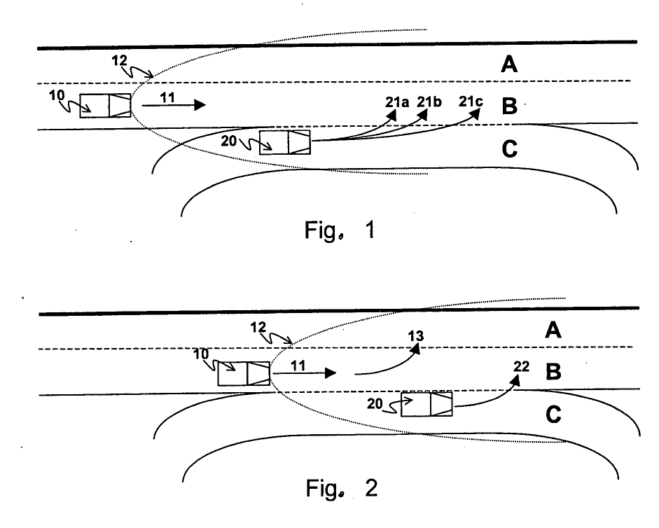

In order to optimize the driving behavior of the vehicle 10 in its breaking behavior, the relative speed of the vehicle 20 relative to vehicle to 10 should be taken into consideration in determining the servo parameters for the vehicle brake system. Therein it is advantageous when the separation of the own vehicle 10 to the at least one detected traffic user 20 is so large, that the reduction and speed of the own vehicle 10 occurs with moderation. Here the operator of the own vehicle 10 is not disturbed by oscillations in distance between the vehicles or a moderate approaching of the own vehicle to the other vehicle 20 and corresponds essentially to his own natural driving behavior. In those cases, as shown for example in FIG. 2, in which the distance of the owned vehicle 10 is relatively small to the at least on detected traffic user 20 and wherein he in accordance with a conventional driving behavior would quickly carry out a change in lane maneuver, the reduction and speed of the own vehicle 10 can advantageously occur rapidly. In the here shown example the other vehicle 20 is located close to the end of the on ramp, so that, in accordance with conventional driving behavior, it can be presumed, that the merging maneuver from lane C to lane B would occur very soon along trajectory 22. Alternatively to a rapid dropping of the vehicle speed of the own vehicle 10 this could in advantageous manner also be so controlled, that a change in lane to an adjacent, away from the detected traffic user 20 (here: lane A) is carried out along for example trajectory 13. Such a behavior, the avoidance of danger, corresponds to the natural behavior of the vehicle operator and is thus not found to be a cause of concern by him.

If this type of change in lane occurs completely automatically, it should be insured, that prior to the change in lane to the lane opposite to the traffic user 20, the adjacent lane A, is checked for avoidance of accidents by means of a sensor system for monitoring adjacent lanes a blind angle monitoring system, it is checked with regard to whether a free of danger change of the own vehicle 10 to lane A is possible.

The result of a checking and monitoring of this type of the occupancy condition of a possible evasion lane can lead to a decision regarding suitable means for reaction to a eminent merging vehicle 20; that is it can be decided whether the operator of the vehicle 10 would prefer a rapid breaking of his own vehicle or whether a deviation to lane A would be considered more natural and comfortable.

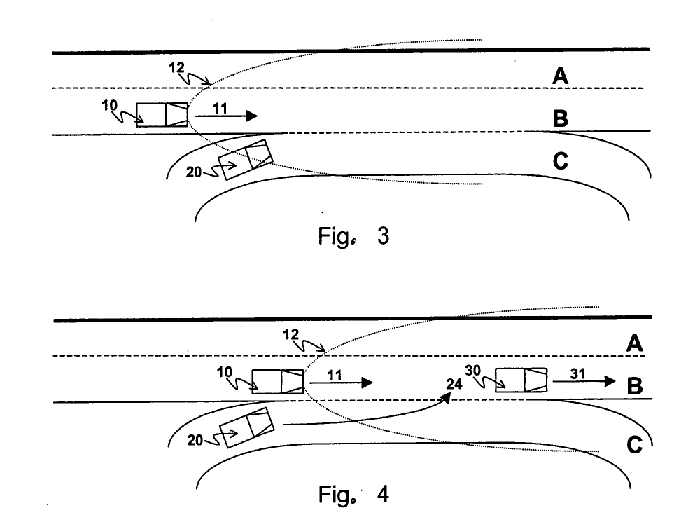

In FIG. 3. a traffic situation is illustrated, in which the separation of the own vehicle 10 to the at least one traffic user 20 in the detection area 12 is relatively small, it however in accordance with the conventional driving behavior still has time remaining for a lane change, the speed of the own vehicle 10 is not reduced since vehicle 10 moves in general substantially faster than the other vehicle 20 it will speedily over take this, so that the operator of the other vehicle 20 can merge behind 10 onto lane B without problem. In an advantageous manner it is however also conceivable, in a situation of this type to moderately increase the speed of the own vehicle 10, if the traffic situation or the traffic regulations or a setting of the cruise control system (Tempomat, Distronic) permit this. In this manner on the one hand the own vehicle 10 distances itself substantially more rapidly from the potential dangerous situation and on the other hand the operator of the other vehicle 20 is given more time for merging, since the lane B is more rapidly opened. If vehicle 10 however is accelerated in advantageous manner the speed thereof should, after passing the other traffic user 20 can be reduced to the speed at which it operated prior to over taking. By this return controlling of the speed the vehicle 10 continues, despite the merger maneuver of an another vehicle on to his lane, continues on its way with the accustomed behavior.

FIG. 4 shows a further merger situation of an on ramp. Herein the own vehicle 10 moves along a multi-lane highway with lanes A and B along lane B in the direction of the indicating 11. On the same lane A there is supplementally a vehicle in traffic 30, which moves in the direction of the indicating arrow 31. A further vehicle 20 moves along lane C, this is however located in the blind area of the own vehicle 10 and is detected by a blind angle monitoring system integrated in the own vehicle 10. Under the assumption that the other vehicle 20 is moving faster than the own vehicle 10, it is to be presumed, that the other vehicle 20 will change lane from C to lane B along the trajectory 24 or similar trajectory between the vehicles 10, 30. In the case that the distance between the vehicles 10, 30 is large or that no preceding vehicle 30 is present, a moderate reduction of the speed of the own vehicle 10 suffices, so that the other vehicle 20 can merge with a safe distance ahead of the own vehicle 10. A substantial reduction is herein brought about thereby, in that for a short time no gas is given. In a case that the vehicles 10, 30, move along with approximately the same speed and follow close to each other, space must be provided for the merger of vehicle 20. The in case it is determined from the view of the vehicle 10 by means of a blind angle monitoring system that no vehicular traffic is located on lane A, it can be presumed, that the vehicle 20 immediately after merging on to lane B will continue changing lane to lane A, so that a stronger engagement of breaks can be extended for a short period of time in vehicle 10. In contrast, in the case that the adjacent lane A is already occupied a stronger actuation of the breaks is brought about in vehicle 10 without delay.

In particularly advantageous manner the inventive process and the inventive device allow themselves to be used to merge from a lane traveled by a vehicle 10 containing the invention to an adjacent lane, upon which other traffic users are located. Herein it is in particular with access to the environment information from the adjacent street areas decided whether the vehicle 10 should merge ahead of or after in particular traffic user traveling there. Depending upon this decision one sets the speed of the own vehicle either above or below the speed of the concerned vehicle participant by suitable selection of the adjustment parameter for the servo means for acceleration or breaking of the own vehicle, so that a safe merger procedure representing a far-sided manner of driving is safely carried out to the adjacent lane.

Now that the invention has been described, we claim:

1. A process for adapting and automated safe distance following guidance of an equipped vehicle (10) to a traffic user (20) merging into the lane (B) of the equipped vehicle (10), comprising:
detecting objects and traffic users (20) ahead of the own vehicle within a sensed area (12) originating from a spacing sensor, and
determining, in an evaluation unit, the positions and speeds of the detected objects and traffic users (20), in order to produce, beginning from this computed data, control parameters in order to selectively influence servo means for acceleration or braking of the equipped vehicle,
wherein in the production of the control parameters, in addition to the data of the objects and traffic users (20) determined in the evaluation unit, also information from a navigation system or another data bank describing the ahead-lying layout of the road is accessed,
and wherein, when from the information regarding the additional layout of the road, it is determined that at least one traffic user exercising conventional driving behavior will change lane to the lane (B) of the equipped vehicle (10), the control parameters for the servo means acting upon the own vehicle (10) are produced in such a manner, that the behavior of the own vehicle (10) is adapted to the at least one detected traffic user (20) according to its speed and/or position.

2. A process according to claim 1, wherein the detection of objects and traffic users (20) occurs by the spacing sensor using millimeter waive length radar, lidar or camera sensors.

3. A process according to claim 1, wherein information describing the ahead lying layout of the road is read from ADAS-Map (Advanced Driver Assistance System), which information includes, in addition to information necessary for vehicle navigation, also supplementally information regarding the number of lanes (A), (B) and/or markers with respect to on ramps and off ramps (C) to highways or major roads.

4. A process according to claim 1, wherein in the cases in which the speed of the at least one detected traffic user (20) is exceeded by the speed of the equipped vehicle (10), the driving behavior of the equipped vehicle is adapted in such a manner to the traffic user (20) that, by suitable adjusting of the controlled parameters, the speed of the own vehicle is reduced to the realm of the speed of the traffic user (20).

5. A process according to claim 4, wherein in those cases in which the spacing of the equipped vehicle (10) to the at least one detected traffic participant (20) is large, the reduction in speed of the equipped vehicle (10) occurs with moderation.

6. A process according to claim 4, wherein in the cases in which the separation of the own vehicle (10) to the at least one detected traffic user (20) is relatively small, the traffic user (20) however following conventional driving behavior would be expected to immediately carry out a lane change, the reduction in the speed of the own vehicle (10) occurs rapidly.

7. A process according to claim 4, wherein in the cases, in which the separation of the own vehicle (10) to the at least one detected traffic user (20) is relatively small, the traffic user (20) however following conventional driving behavior would be expected to immediately carry out a lane change, the equipped vehicle (10) is programmed to carry out a lane change to an adjacent lane (A) opposite to the detected traffic user (20).

8. A process according to claim 7, wherein prior to the lane change to adjacent lane (A) opposite to the detected traffic user (20), this lane (A) is examined with a sensor system for monitoring adjacent lanes, in particular a blind angle monitoring system, with regarding to whether a safe change in lane of the equipped vehicle (10) to this lane (A) is possible.

9. A process according to claim 4, wherein in the cases, in which the distance of the equipped vehicle (10) to the at least one detected traffic user (20) is relatively small, yet still sufficient to allow time for a lane change in conventional driving behavior, the speed of the own vehicle (10) is not reduced.

10. A process according to claim 9, wherein, traffic situations and regulations permitting, the speed of the equipped vehicle (10) is moderately increased.

11. A process according to claim 10, wherein the speed of the equipped vehicle (10), after passing the at least one detected traffic user (20), is again reduced to resume the speed prior to the increasing of the speed.

12. A device for adapting an automatic safe following guidance of an equipped vehicle (10) to traffic users (20) merging to this lane (B),
including a spacing sensor for detecting objects and traffic users (20) located ahead of the equipped vehicle (10),
further including an evaluation unit for determining the position and relative speed of the detected objects and traffic users (20), and
a means for acting, beginning with the determined position and speed, on a servo means for accelerating or braking the equipped vehicle (10),
wherein the device is in communication with a navigation system or another data bank, in order to access additional information describing the layout of the road for producing control parameters, in addition to the evaluation unit determined data of the object and the traffic users (20).

13. A device according to claim 12, wherein the spacing sensor is a millimeter waive length radar, lidar or camera sensor.

14. A device according to claim 12, wherein the data bank, from which supplemental information describing the ahead lying layout of the road is read, includes an ADAS-Map.

15. A device according to claim 12, wherein the device is in communication with a sensor system for monitoring an adjacent lane, in particular a blind angle monitoring system, in order, prior to a change in lane of the equipped vehicle (10) to a adjacent lane (A) opposite to the detected traffic user (20), this adjacent lane is examined to the extent as to whether a safe change in that direction is possible.

16. A process as in claim 1, wherein for merging in to the lane travelled by the equipped vehicle (10) by vehicles from a lane adjacent, in which other traffic users are located,
for preparing for the merging, depending upon whether the vehicle is to merge ahead of or behind a particular traffic user, the speed of the equipped vehicle is either increased above or reduced below the speed of the particular traffic user by appropriate selection of the control parameters, using the servo means for acceleration or braking of the own vehicle.
